(19) United States
(12) Patent Application Publication
(10) Pub. No.: US 2025/0161815 A1
(43) Pub. Date: May 22, 2025

(54) METHOD AND APPARATUS FOR CONTROLLING VIRTUAL OBJECT, DEVICE, STORAGE MEDIUM, AND PRODUCT

(71) Applicant: Tencent Technology (Shenzhen) Company Limited, Shenzhen (CN)

(72) Inventors: Jinfeng YE, Shenzhen (CN); Yan ZHENG, Shenzhen (CN)

(21) Appl. No.: 19/030,865

(22) Filed: Jan. 17, 2025

Related U.S. Application Data
(63) Continuation of application No. PCT/CN2023/129276, filed on Nov. 2, 2023.

(30) Foreign Application Priority Data
Feb. 7, 2023 (CN) 202310126035.9

(51) Int. Cl. A63F 13/58

(52) U.S. Cl. CPC A63F 13/58

(57) ABSTRACT

Disclosed are a method for controlling a virtual object performed by a computer device. The method includes: obtaining a first parameter configured for controlling a virtual object; determining an integer part and a fractional part of the first parameter; determining an integer representation of the fractional part according to a preset number of fractional digits; determining an integer representation of the first parameter according to the integer representation of the fractional part and the integer part; and controlling the virtual object according to the integer representation corresponding to the first parameter.

### CROSS-REFERENCE TO RELATED APPLICATIONS

This application is a continuation application of PCT Patent Application No. PCT/CN2023/129276, entitled “METHOD AND APPARATUS FOR CONTROLLING VIRTUAL OBJECT, DEVICE, STORAGE MEDIUM, AND PRODUCT” filed on Nov. 2, 2023, which claims priority to Chinese Patent Application 202310126035.9, entitled “METHOD AND APPARATUS FOR CONTROLLING VIRTUAL OBJECT, DEVICE, AND STORAGE MEDIUM” and filed on Feb. 7, 2023, both of which are incorporated herein by reference in their entirety.

### FIELD OF THE TECHNOLOGY

Embodiments of this application relate to the technical field of computers and Internet, and in particular, to a method and an apparatus for controlling a virtual object, a device, a storage medium, and a product.

### BACKGROUND OF THE DISCLOSURE

In a game scenario, a player may control a virtual character to perform complex physical interaction with a virtual scenario and a virtual character controlled by another player. To implement the foregoing physical interaction, it is necessary to perform calculation according to a parameter for controlling a virtual object to obtain calculation result data, and control to the virtual object according to the calculation result data.

In a related art, a method for controlling a virtual object is provided. Terminal devices where different clients in the same scenario are located separately convert, by using compilers or hardware, parameters that are configured for controlling virtual objects and that are represented by fractions into corresponding integer representations, perform calculations according to the integer representations corresponding to the parameters to obtain calculation result data, and control the virtual objects according to the calculation result data.

Because the parameters represented by the fractions cannot be accurately represented on the compilers or hardware, rounding rules used by different compilers or hardware when the parameters represented by the fractions are represented are different, resulting in different calculation result data obtained by various clients and inconsistent control on the virtual objects.

### SUMMARY

Embodiments of this application provide a method and an apparatus for controlling a virtual object, a device, a storage medium, and a product. Technical solutions are as follows:

According to one aspect of the embodiments of this application, a method for controlling a virtual object is performed by a computer device. The method includes:
obtaining a first parameter configured for controlling a virtual object;
determining an integer part and a fractional part of the first parameter;
determining an integer representation of the fractional part according to a preset number of fractional digits;
determining an integer representation of the first parameter according to the integer representation of the fractional part and the integer part; and
controlling the virtual object according to the integer representation corresponding to the first parameter.

According to one aspect of the embodiments of this application, a computer device is provided. The computer device includes a processor and a memory. The memory stores a computer program, and the processor is configured to execute the computer program to implement the foregoing method for controlling a virtual object.

According to one aspect of the embodiments of this application, a non-transitory computer-readable storage medium is provided. The non-transitory computer-readable storage medium stores a computer program, and the computer program is loaded and executed by a processor to implement the foregoing method for controlling a virtual object.

The technical solutions provided in the embodiments of this application include the following beneficial effects:
at least one parameter configured for controlling a virtual object is converted into an integer representation corresponding to the at least one parameter, calculation is performed according to the integer representation corresponding to the at least one parameter to obtain calculation result data, and the virtual object is controlled according to the calculation result data. This application provides a software implementation method for converting a parameter represented by a fraction into an integer representation. A client constructs an integer representation of a parameter by using the same method described above, without relying on a compiler or hardware, so that uncertainty of the parameter represented by the fraction caused by inherent defects of the compiler or the hardware can be avoided, and certainty of integer representations of parameters obtained by different clients is ensured, thereby ensuring certainty of calculation result data, and maintaining control consistency of a virtual object by various clients.

### BRIEF DESCRIPTION OF THE DRAWINGS

FIG. 1 is a schematic diagram of a solution implementation environment according to an embodiment of this application.

FIG. 2 is a schematic diagram of a method for controlling a virtual object according to an embodiment of this application.

FIG. 3 is a flowchart of a method for controlling a virtual object according to an embodiment of this application.

FIG. 4 is a flowchart of a method for controlling a virtual object according to an embodiment of this application.

FIG. 5 is a schematic diagram of determining an integer representation of a first parameter according to an embodiment of this application.

FIGS. 6A and 6B are schematic diagrams of an experimental result according to an embodiment of this application.

FIG. 7 is a block diagram of an apparatus for controlling a virtual object according to an embodiment of this application.

FIG. 8 is a schematic block diagram of a computer device according to an embodiment of this application.

### DESCRIPTION OF EMBODIMENTS

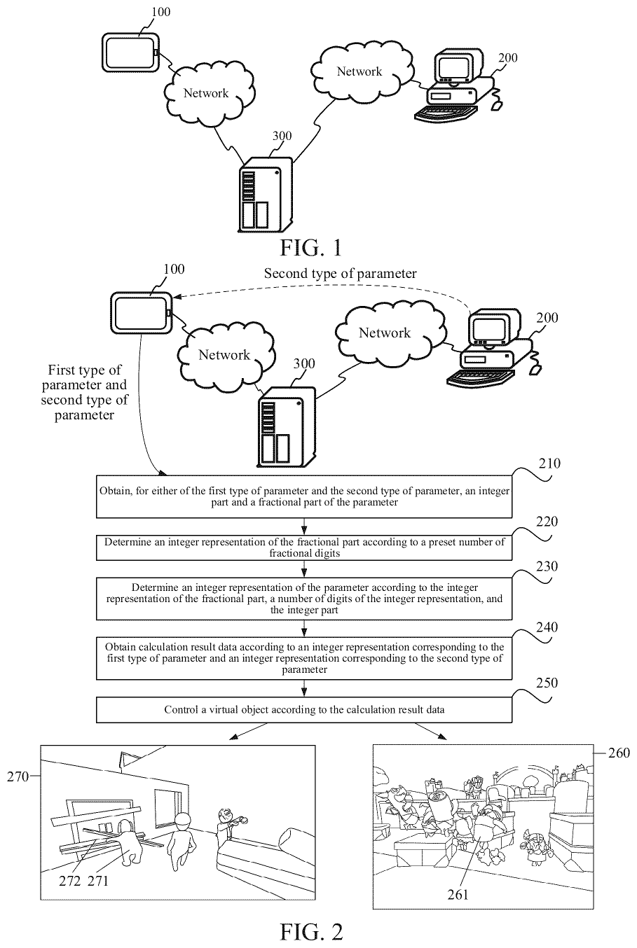

Please refer to FIG. 1, which is a schematic diagram of a solution implementation environment according to an embodiment of this application. The solution implementation environment may be implemented as architecture of a system for controlling a virtual object. The solution implementation environment may include: a first terminal device 100 and a second terminal device 200.

A terminal device (for example, the first terminal device 100 and the second terminal device 200 described above) may be an electronic device such as a personal computer (PC), a tablet computer, a mobile phone, a wearable device, or a vehicle terminal. A client running a target application may be installed in the terminal device. The target application may be a game application, or may be another application that provides a virtual object control function, such as a life service application, a social application, or a motion application. This is not limited in this application. Taking the game application as an example, in a game battle, a user controls a virtual character to complete the game battle. For example, the user controls the virtual object to complete the game battle through a method for controlling a virtual object provided in the embodiments of this application. In addition, this application does not limit a form of the target application, which includes, but is not limited to, an application (App) installed in the terminal device, an applet, and the like, or may be in a form of a web page.

The first terminal device 100 and the second terminal device 200 may directly communicate with each other, or may communicate with each other through a server 300. For example, the first terminal device 100 transmits a first type of parameter to the server 300, and the server 300 forwards the first type of parameter to the second terminal device 200. The first type of parameter refers to at least one input parameter for a user to control the virtual object in the client installed in the first terminal device 100.

The first terminal device 100 and the second terminal device 200 may communicate with each other through a network, such as a wired or wireless device.

In the method for controlling a virtual object provided in the embodiments of this application, various operations may be performed by a computer device. The computer device refers to an electronic device having data calculating, processing, and storage capabilities. For example, the computer device may be the terminal device. Taking the solution implementation environment shown in FIG. 1 as an example, the first terminal device may perform the method for controlling a virtual object (for example, the client that is installed in the first terminal device 100 and that runs the target application performs the method for controlling a virtual object), or the second terminal device 200 may perform the method for controlling a virtual object. This is not limited in this application. For ease of description, in the following method embodiments, take an example in which various operations of the method for controlling a virtual object are only performed by the computer device for description.

In some embodiments, technical solutions provided in this application may be applied to a game scenario. For example, the first terminal device 100 obtains parameters respectively provided by at least two clients, processes the parameters that are respectively provided by the at least two clients and indicated by fractions to obtain integer representations of the parameters respectively provided by the at least two clients, performs calculation according to the integer representations of the parameters respectively provided by the at least two clients to obtain calculation result data, and controls the virtual object according to the calculation result data. The at least two clients respectively control the virtual object in a lock-step synchronization mode. Lock-step synchronization refers to a synchronization mode of a game. Only input of a player is synchronized in a game process, such as states of a mouse, a keyboard, a gamepad, and a touchscreen, and most states in a game world are locally simulated by the client. Therefore, the lock-step synchronization greatly relies on certainty of game simulation logic to ensure consistent representations of various clients.

For example, as shown in FIG. 2, the first terminal device 100 obtains a first type of parameter of a target application installed in the first terminal device 100 and a second type of parameter of a target application installed in a second terminal device 200. The first type of parameter refers to at least one input parameter for a user to control the virtual object in the client installed in the first terminal device 100. The second type of parameter refers to at least one input parameter for a user to control the virtual object in the client installed in the second terminal device 200.

The first terminal device 100 obtains, for either of the first type of parameter and the second type of parameter, an integer part and a fractional part of the parameter (210); determines an integer representation of the fractional part according to a preset number of fractional digits (220); determines an integer representation of the parameter according to the integer part, the integer representation of the fractional part, and a number of digits of the integer representation (230); obtains calculation result data according to an integer representation corresponding to the first type of parameter and an integer representation corresponding to the second type of parameter (240); and controls the virtual object according to the calculation result data (250). For example, the first terminal device 100 controls a virtual object 261 shown on a user interface 260 of the target application to implement movement of the virtual object 261. For another example, the first terminal device 100 controls a virtual object 271 shown on a user interface 270 of the target application to implement interaction between the virtual object 271 and another virtual object 272.

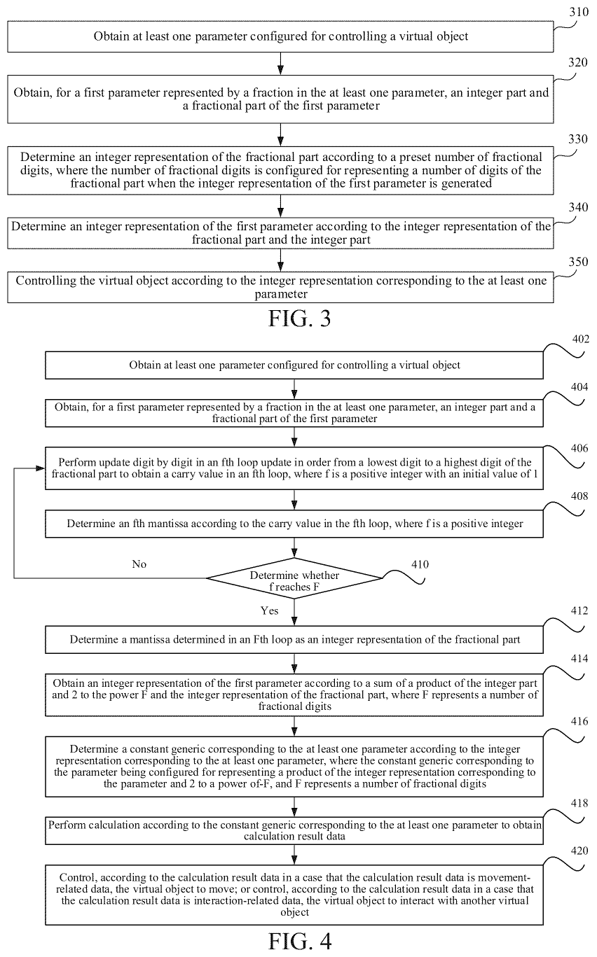

Please refer to FIG. 3, which is a flowchart of a method for controlling a virtual object according to an embodiment of this application. Taking an example in which the method is performed by a computer device, the method may include at least one operation of the following operations 310 to 350.

Operation 310: Obtain at least one parameter configured for controlling a virtual object.

The virtual object refers to an object in a virtual scenario presented by a target application. The virtual object may be a virtual character or a virtual item. This is not limited in this application. For example, when the virtual object is a virtual character, the virtual character is controlled according to an instruction triggered by a user to complete events such as movement of the virtual character and skill release. For example, when the virtual object is a virtual item, the virtual item is controlled according to an instruction triggered by a user to complete an interaction event with a virtual character. For example, a user controls the virtual object to push a box, or controls the virtual object to drive a car.

The at least one parameter configured for controlling the virtual object refers to at least one parameter for controlling the virtual object to execute a behavior. Alternatively, the at least one parameter refers to at least one parameter for controlling appearance representation of the virtual object. In the embodiments of this application, take an example in which the at least one parameter is a parameter for controlling the virtual object to execute a behavior. For example, the at least one parameter configured for controlling the virtual object is a parameter for controlling the virtual object to move, and the at least one parameter may include a movement step length of the virtual object, a movement operation of the user on the virtual object, and the like. For example, the at least one parameter configured for controlling the virtual object is a parameter for controlling the virtual object to release a skill, and the at least one parameter may include damage caused by the virtual object releasing the skill, a skill release operation of the user on the virtual object, a direction in which the virtual object releases the skill, and the like. For example, the at least one parameter configured for controlling the virtual object is a parameter for controlling the virtual object to interact with another virtual object, and the at least one parameter may include a movement step length of the another virtual object that interacts with the virtual object, an operation of the user on interaction between the virtual object and the another virtual object, or the like.

The foregoing parameter may be a decimal number, an octal number, or a hexadecimal number. This is not limited in this application. In the embodiments of this application, only take an example in which the foregoing parameter is a decimal number for description.

In some embodiments, the foregoing parameters include parameters from at least two clients, and the at least two clients may be installed in a same terminal device, or may be installed in different terminal devices. This is not limited in this application. For example, the at least two clients are installed in a same terminal device in a form of application cloning. Application cloning refers to a form that a plurality of clients simultaneously run in the terminal device. Different user accounts may be logged in each client to implement a multi-user account login operation on one terminal device. For example, two game clients are run on one terminal device in the form of application cloning. Different user accounts are logged in each client. Two user accounts are in a same game battle. For example, the at least two clients are respectively installed in different terminal devices. For example, different user accounts participating in the same game battle are respectively logged in the clients of different terminal devices.

Operation 320: Obtain, for a first parameter represented by a fraction in the at least one parameter, an integer part and a fractional part of the first parameter.

A fractional representation refers to that a digit exists to the right of a decimal point of the parameter, for example, 3.14, 2.5674, 4.000, and 7.91159.

Taking the decimal point as a boundary, a digit to the left of the decimal point of the first parameter is an integer part of the first parameter, and a digit to the right of the decimal point of the first parameter is a fractional part of the first parameter. For example, the first parameter is 3.14, an integer part of the first parameter is 3, and a fractional part is 14 (that is, 0.14). For example, the first parameter is 4.000, an integer part of the first parameter is 4, and a fractional part is 000 (that is, 0.000).

Operation 330: Determine an integer representation of the fractional part according to a preset number of fractional digits. The number of fractional digits is configured for representing a number of digits of the fractional part when the integer representation of the first parameter is generated.

In some embodiments, the number of fractional digits is a constraint on the number of digits of a converted integer representation when the fractional part is converted into an integer representation. The number of fractional digits is a preset fixed value, and is the same as a number of fractional digits of the integer representation when the fractional part is converted into the integer representation when the fractional part corresponding to the first parameter is different.

The integer representation is a binary integer representation, that is, an integer is represented through binary values of 0 and 1. The number of fractional digits is configured for representing a number of digits of the fractional part when the integer representation of the first parameter is generated, and the number of fractional digits is preset. For example, if the number of digits of the integer representation of the first parameter is 32 bits, and the preset number of fractional digits is 10 digits, the integer representation of the first parameter is a 32-digit integer representation, where 10 bits are configured for representing the fractional part of the first parameter. The number of digits of the integer representation is a number of digits of a generated integer representation of the first parameter.

A value of the number of fractional digits and a value of the number of digits of the integer representation may be preset values. For example, the value of the number of fractional digits and the value of the number of digits of the integer representation may be set by a developer when applying the method for controlling a virtual object.

In some embodiments, when the integer representation corresponding to the fractional part is determined, loop iteration update is performed on the fractional part based on the number of fractional digits. Taking example in which the number of fractional digits is F is description, the loop iteration update is performed on the fractional part for F times. In an f^{th} loop update, a carry value in the f^{th} loop is determined, where f is a positive integer with an initial value of 1. An f^{th} mantissa is determined according to the carry value in the f^{th} loop. The integer representation of the fractional part is determined according to the f^{th} mantissa and the number of fractional digits. The carry value refers to a carry generated in a calculation process. For example, in decimal addition, 15+7=22, where single digits 5 and 7 are added to obtain 12, 2 in a single digit of 12 is reserved in a single digit as a single digit of a sum 22, and 1 in a tens digit of 12 serves as the carry value and is added to the digit 1 in a tens digit of 15 to obtain 2 in a tens digit of the sum 22.

In some embodiments, update is performed digit by digit in order from a lowest digit to a highest digit of the fractional part to obtain the carry value in the f^{th} loop, where f is a positive integer with an initial value of 1. An f^{th} mantissa is determined according to the carry value in the f^{th} loop, where f is a positive integer.

For example, taking the parameter 3.14 as an example, update is performed digit by digit in the order from the lowest digit to the highest digit of the fractional part, update is performed digit by digit in order from 4 to 1, that is, calculation is performed digit by digit in the order from 4 to 1 to update the carry value, and the carry value obtained according to a highest digit of the fractional part is determined as a first carry value.

In some embodiments, the first carry value is initialized to 0. Update is performed on the fractional part digit by digit according to the first carry value, and update is performed on the first carry value. The first carry value obtained by performing update on the highest digit of the fractional part as the carry value in the f^{th} loop.

Taking the parameter 3.14 as an example, the first carry value is initialized to 0. In a first loop update process, update is performed digit by digit in the order from 4 to 1 according to the first carry value. For example, the first carry value n is 0, it is defined that for a first digit l₁=4 that l₁=4*2+n=8, in this case, 8<10, and the first carry value is still 0. It is continued to be defined for a second digit l₂=1 that l₂=1*2+n=2, in this case, 2<10, and the first carry value is still 0. In this case, the highest digit of the fractional part of 3.14 is reached, so the first carry value is determined as 0. In the foregoing process, if an updated digit is greater than or equal to 10, the first carry value is defined as 1, and the next digit is continued to be updated.

In some embodiments, it is defined that f=f+1 when f is less than F, and the operation of performing update digit by digit in the order from the lowest digit to the highest digit of the fractional part to obtain the carry value in the f^{th} loop is started to be performed again, where F represents a preset number of fractional digits. An F^{th} mantissa is determined as the integer representation of the fractional part when f is equal to F.

For example, F=10, it is defined that f=f+1 when f is less than 10, and the operation of performing update digit by digit in the order from the lowest digit to the highest digit of the fractional part to obtain the carry value in the f^{th} loop is started to be performed again. A mantissa determined in a tenth loop update is determined as the integer representation of the fractional part when f is equal to 10.

By the foregoing method, digits of the fractional part of the first parameter are parsed one by one to obtain the fractional part of the first parameter, and then obtain the integer representation of the fractional part, thereby ensuring accuracy of the integer representation of the fractional part.

Operation 340: Determine an integer representation of the first parameter according to the integer representation of the fractional part and the integer part.

In some embodiments, an integer representation of the integer part is determined according to the integer part, and the integer representation of the first parameter is determined according to a sum of the integer representation of the integer part and an integer representation of the fractional part.

For example, the first parameter is 3.14, the integer part is 3, and the integer part 3 is converted into the integer representation of the integer part. The sum of the integer representation of the integer part and the integer representation of the fractional part are calculated, and the sum is determined as the integer representation of the first parameter.

Operation 350: Control the virtual object according to the integer representation corresponding to the at least one parameter.

In some embodiments, calculation is performed according to the integer representation corresponding to the at least one parameter to obtain calculation result data, and the virtual object is controlled based on the calculation result data.

That is, if the first parameter and a second parameter need to be calculated, calculation is performed by using the integer representation of the first parameter and an integer representation of the second parameter to obtain the calculation result data.

The foregoing calculation may be four arithmetic operations of addition, subtraction, multiplication, and division, or may be a compound operation of any combination of addition, subtraction, multiplication, and division. This is not limited in this application.

For example, multiplication calculation is performed according to the integer representation corresponding to the at least one parameter to obtain the calculation result data. For example, parameters that control the virtual object to move are a speed of the virtual object and a moving time of the virtual object, and multiplication calculation is performed according to the speed of the virtual object and the moving time of the virtual object to obtain a moving distance of the virtual object.

For example, addition calculation is performed after the multiplication calculation is performed according to the integer representation corresponding to at least one parameter to obtain the calculation result data. For example, a parameter for controlling the virtual object to move are a speed of the virtual object, a moving time of the virtual object, and initial position coordinates of the virtual object. Multiplication calculation is performed according to the speed of the virtual object and the moving time of the virtual object, and then addition calculation is performed with the initial position coordinates of the virtual object to obtain position coordinates of the virtual object after movement.

The integer representation of the parameter obtained by the foregoing method has certainty, and the calculation result data calculated according to the integer representation of the parameter has certainty.

In some embodiments, a constant generic corresponding to the at least one parameter is determined according to the integer representation corresponding to the at least one parameter. The constant generic corresponding to the parameter is configured for representing a product of the integer representation corresponding to the parameter and 2 to the power of −F. F represents the preset number of fractional digits. Calculation is performed according to the constant generic corresponding to the at least one parameter to obtain the calculation result data.

For example, the integer representation of the first parameter is i, and the constant generic of the first parameter is determined according to the integer representation of the first parameter, where F represents a number of fractional digits of the first parameter.

In some embodiments, a number of fractional digits of the calculation result data has certainty. For example, the number of fractional digits of the calculation result data is F1. Calculation is performed according to the integer representation corresponding to the at least one parameter to obtain the calculation result data. The number of fractional digits of the calculation result data is F1. The foregoing calculation may be four arithmetic operations, or may be a combination of the four arithmetic operations. This is not limited in this application.

In some embodiments, half-value rounding up is performed on the calculation result data when a sum of the number of fractional digits corresponding to the at least one parameter is greater than the number of fractional digits of the calculation result data. The half-value rounding up refers to that a round value y=x+0.5 if the fractional part of a value x of the calculation result data is 0.5. The calculation result data is rounded by using a half-value rounding up rule to avoid a problem of integer overflow or precision loss.

By the foregoing method, calculation is performed on the at least one parameter to avoid the problem of integer overflow or precision loss caused by a limited value range that can be represented because a digit value of the calculation result data is the same as a digit value of the at least one parameter.

In some embodiments, the virtual object is controlled, according to the calculation result data, to move when the calculation result data is movement-related data. For example, the calculation result data is the movement-related data, and the virtual object is controlled, according to the calculation result data, to move on a user interface of a target application.

In some embodiments, the virtual object is controlled, according to the calculation result data, to interact with another virtual object when the calculation result data is interaction-related data. For example, the calculation result data is the interaction-related data, and the virtual object is controlled, according to the calculation result data, to interact with the another virtual object. The another virtual object may be a virtual character, or may be a virtual object. This is not limited in this application. For example, the another virtual object is a virtual character, and the virtual object is controlled, according to the calculation result data, to interact with the another virtual character. For example, the virtual object is controlled to make a dialog with a non-player character (NPC). For example, the another virtual object is a virtual object, and the virtual object is controlled, according to the calculation result data, to interact with the another virtual object. For example, the virtual object is controlled to push a box, and the another virtual object is the box.

In conclusion, according to the technical solutions provided in the embodiments of this application, at least one parameter configured for controlling a virtual object is converted into an integer representation corresponding to the at least one parameter, calculation is performed according to the integer representation corresponding to the at least one parameter to obtain calculation result data, and the virtual object is controlled according to the calculation result data. This application provides a software implementation method for converting a parameter represented by a fraction into an integer representation. A client constructs an integer representation of a parameter by using the same method described above, without relying on a compiler or hardware, so that uncertainty of the parameter represented by the fraction caused by inherent defects of the compiler or the hardware can be avoided, and certainty of integer representations of parameters obtained by different clients is ensured, thereby ensuring certainty of calculation result data, and maintaining control consistency of a virtual object by various clients.

According to the method provided in this embodiment, a number of loop updates is determined based on a number of fractional digits of a fractional part, and in each loop update process, a mantissa is determined by determining a carry value, and the mantissa corresponding to the number of fractional digits is determined as an integer representation of the fractional part through iterative update, thereby improving integer conversion efficiency of the fractional part.

According to the method provided in this embodiment, in each loop update process, a value in a fraction is updated through a preset algorithm, a first carry value is updated according to an update result, and an update value corresponding to each fraction is sequentially determined based on a previously determined carry value according to a number of digits in the fraction, so as to determine the carry value during one loop update, thereby improving accuracy and efficiency of determining the carry value.

Please refer to FIG. 4, which is a flowchart of a method for controlling a virtual object according to another embodiment of this application. The method may include at least one operation of the following operations 402 to 420.

Operation 402: Obtain at least one parameter configured for controlling a virtual object.

In some embodiments, at least one parameter includes parameters respectively provided by at least two clients, and the at least two clients respectively control the virtual object in a lock-step synchronization mode.

In some embodiments, at least two clients may be installed on the same terminal device, or may be installed on different terminal devices. This is not limited in this application.

Lock-step synchronization refers to a synchronization mode of a game. Only input of a player is synchronized in a game process, such as states of a mouse, a keyboard, a gamepad, and a touchscreen, and most states in a game world are locally simulated by the client. Therefore, the lock-step synchronization greatly relies on certainty of game simulation logic to ensure consistent representations of various clients.

Operation 404: Obtain, for a first parameter represented by a fraction in the at least one parameter, an integer part and a fractional part of the first parameter.

In some embodiments, digits following the decimal point of the first parameter are traversed one by one from a highest digit, and 1 digits are obtained to obtain the fractional part of the first parameter. 1 is a positive integer and 1 is less than or equal to a maximum threshold.

In some embodiments, the maximum threshold is determined according to a preset number of fractional digits and a number of digits of an integer representation. For example, the maximum threshold may be a value of the number of fractional digits, or may be a value of the number of digits of an integer representation. For example, the maximum threshold may be a minimum value of the number of fractional digits and the number of digits of the integer representation. For example, if the number of digits of the integer representation is D and the number of fractional digits is F, the maximum threshold is min (F, D). For example, if the number of digits of the integer representation is D=32, and the number of fractional digits is F=10, the maximum threshold is min (F, D) =10, that is, 10 digits in 32 digits of the integer representation are configured for expressing the fractional part. For example, if the number of digits of the integer representation is D=32, and the number of fractional digits is F=35, the maximum threshold is min (F, D)=32 min (F, D)=32, that is, 32 digits of the integer representation are all configured for expressing the fractional part.

In some embodiments, an array is created. A j^{th} digit for the digits following the decimal point of the first parameter is obtained. An initial value of j corresponds to the highest digit following the decimal point of the first parameter. The j^{th} digit is added to the array in order from the highest digit to a lowest digit of the first parameter. It is defined that j=j+1 when the j^{th} digit is followed by another digit, and j is less than the maximum threshold, and the operation of obtaining the j^{th} digit is started to be performed again. The fractional part of the first parameter is obtained according to 1 digits recorded in the array when the j^{th} digit is not followed by another digit, or when the j^{th} digit is followed by another digit and j is equal to the maximum threshold.

In some embodiments, capacity of the array is determined according to the number of digits of the integer representation. For example, the capacity of the array is greater than or equal to the number of digits of the integer representation. For example, the number of digits of the integer representation is D, and a size of the array is D+1.

For example, the array is represented as fractionDigits. Taking a first parameter 3.14 as an example, for digits following a decimal point of the first parameter 3.14, a first digit “1” is obtained, and the first digit is added to the array according to order from a highest digit to a lowest digit of the first parameter 3.14 to obtain fractionDigits₀=1. If the first digit is followed by another digit and 1 is less than the maximum threshold, it is defined j=1+1=2, a second digit “4” is obtained, and the second digit is added to the array to obtain fractionDigits₁=4; and if the second digit is not followed by another digit, a fractional part fractionDigits of the first parameter 3.14 is obtained according to the two digits recorded in the array, as shown in Table 1.

TABLE 1
fractional part fractionDigits of first parameter 3.14

| fractionDigits₀ | fractionDigits₁ |
|---|---|
| 1 | 4 |

By the foregoing method, the digits of the fractional part of the first parameter are parsed one by one to obtain the fractional part of the first parameter, so as to ensure the certainty of the fractional part of the first parameter, thereby ensuring the certainty of the integer representation of the fractional part.

In some embodiments, the first parameter is traversed digit by digit from the highest digit of the first parameter until traversing to a decimal point of the first parameter to obtain the integer part of the first parameter.

For example, the first parameter is 3.14. The first parameter is traversed digit by digit from the highest digit of the first parameter 3.14 until traversing to a decimal point of the first parameter to obtain the integer part 3 of the first parameter.

In some embodiments, a value of the first variable is initialized to 0. An i^{th} digit in the first parameter is obtained in order from the highest digit to a lowest digit of the first parameter. An initial value of i corresponds to the highest digit of the first parameter. A product of the first variable and 10 is calculated, the i^{th} digit is added, and an obtained result is assigned to the first variable. It is defined that i=i+1 when the i^{th} digit is not followed by the decimal point, and the operation of obtaining an i^{th} digit in the first parameter is started to be performed again. A value of the first variable is determined as the integer part of the first parameter when the i^{th} digit is followed by the decimal point. The first variable is configured for storing a variable generated in a process of determining the integer part of the first parameter. The foregoing process is a traversing process. The value of the first variable has no meaning when the integer part of the first parameter is not traversed. The value of the first variable is the integer part of the first parameter when the integer part of the first parameter is traversed.

For example, the first variable may be represented as mantissa. Taking the first parameter 13.14 as an example, the value of the first variable is initialized to mantissa=0, a first digit “1” in the first parameter is obtained in order from a highest digit to a lowest digit of the first parameter, a product of the first variable and 10 is calculated, the first digit “1” is added, and an obtained result is assigned to the first variable, where mantissa=0*10+1=1. If the first digit is not followed by a decimal point, it is defined that i=1+1=2, a second digit “3” in the first parameter is obtained, a product of the first variable and 10 is calculated, the second digit “3” is added, and an obtained result is assigned to the first variable, where mantissa=1*10+3=13. If the second digit is followed by a decimal point, the value of the first variable is determined as the integer part of the first parameter to obtain the integer part 13 of the first parameter.

By the foregoing method, the digits of the integer part of the first parameter are parsed one by one to obtain the integer part of the first parameter, so as to ensure the certainty of the integer part of the first parameter, thereby ensuring the certainty of the integer representation of the integer part.

In some embodiments, an absolute value of a maximum value of the integer part is calculated according to the number of digits of the integer representation and the number of fractional digits. For example, the number of digits of the integer representation is D, and the number of fractional digits is F. If the first parameter is a positive number, the absolute value of the maximum value of the integer part is obtained by subtracting 1 from 2to the power of D−1−F. If the first parameter is a negative number, the absolute value of the maximum value of the integer part is 2 to the power of D−1−F.

For example, the absolute value of the maximum value of the integer part may be represented as wholeOverflow. Taking an example in which the number of digits of the integer representation D=32 and the number of fractional digits F=10 as an example, if the first parameter is a positive integer, wholeOverflow=2D−1−F−1=221−1. If the first parameter is a negative integer, wholeOverflow=2D−1−F=221.

In some embodiments, if the obtained integer part of the first parameter is greater than the absolute value of the maximum value of the integer part, a process of parsing the first parameter is terminated, and an overflow error is reported to a user. Therefore, a case in which the integer part of the first parameter overflows caused by setting the number of fractional digits to be excessively large is avoided.

Operation 406: Perform update digit by digit in an f^{th} loop update in order from a lowest digit to a highest digit of the fractional part to obtain a carry value in an f^{th} loop, where f is a positive integer with an initial value of 1.

In some embodiments, the first carry value is initialized to 0. In the f^{th} loop update, an n^{th} digit in the fractional part is obtained in the order from the lowest digit to the highest digit of the fractional part of the first parameter, where an initial value of n represents the lowest digit of the fractional part. A product of the n^{th} digit and 2 is calculated, and the first carry value is added to obtain a processed n^{th} digit. A difference between the processed n^{th} digit and 10 is assigned to the n^{th} digit when the processed n^{th} digit is greater than or equal to 10, and the first carry value is assigned to 1. The processed n^{th} digit is assigned to an n^{th} digit when the processed n^{th} digit is less than 10, and the first carry value is assigned to 0. It is defined that n=n−1 when n is greater than 1, and the operation of obtaining an n^{th} digit in the fractional part is started to be performed again. The first carry value obtained by processing the first digit is determined as a carry value in the f^{th} loop when n is equal to 1.

For example, the first carry value may be represented as carry₁. The carry value in the f^{th} loop may be represented as carry. Taking the first parameter 3.14 as an example, the first carry value is initialized to carry₁=0. A second digit fractionDigits₁=4 in the fractional part is obtained in order from a lowest digit to a highest digit of the fractional part of the first parameter 3.14, a product of the second digit and 2 is calculated, the first carry value carry₁=0 is added to obtain a processed second digit fractionDigits_{c1}=8, the processed second digit fractionDigits_{c1} is less than 10, and the processed second digit is assigned to the second digit, fractionDigits₁=8, and the first carry value carry₁=0. When 2 is greater than 1, it is defined that n=2−1=1, the first digit fractionDigits₀=1 in the fractional part is obtained, a product of the first digit and 2 is calculated, the first carry value carry₁=0 is added to obtain a processed first digit fractionDigits_{c0}=2, the processed second digit fractionDigits_{c1} is less than 10, the processed second digit is assigned to the second digit, fractionDigits₀=2, and the first carry value carry₁=0. When 1 is equal to 1, the first carry value carry₁=0 obtained by processing the first digit is determined as the first carry value, and carry=0.

Operation 408: Determine an f^{th} mantissa according to the carry value in the f^{th} loop, where f is a positive integer.

The mantissa is configured for storing a variable generated in a process of determining the integer representation of the fractional part. The f^{th} mantissa is a value determined based on the carry value and a preset algorithm. In a case that f does not reach F, the f^{th} mantissa has no meaning. In a case that f reaches F, the f^{th} mantissa is the integer representation of the fractional part.

In some embodiments, a product of an (f−1)^{th} mantissa and 2 is calculated, and the carry value in the f^{th} loop is added to obtain the f^{th} mantissa. When f=1, a 0th mantissa is 0.

For example, the mantissa may be represented as fractionRaw. When f=1, the 0th mantissa is 0, and a first mantissa is fractionRaw=0*2+0=0.

Operation 410: Determine whether f reaches F, and if yes, perform the following operation 412; or if no, define f=f+1, and the operation 406 is started to be performed again, where F represents a number of fractional digits.

TABLE 2
A parsing process of an integer representation of a fractional part of a first parameter
3.14 (a number of fractional digits F = 10)

| f | fractionDigits₀ | carry | fraction Digits₁ | carry | fractionRaw |
|---|---|---|---|---|---|
| 0 | 1 | 0 | 4 | 0 | 0 |
| 1 | 2 | 0 | 8 | 0 | 0 |
| 2 | 5 | 0 | 6 | 1 | 0 |
| 3 | 1 | 1 | 2 | 1 | 1 |
| 4 | 2 | 0 | 4 | 0 | 2 |
| 5 | 4 | 0 | 8 | 0 | 4 |
| 6 | 9 | 0 | 6 | 1 | 8 |
| 7 | 9 | 1 | 2 | 1 | 17 |
| 8 | 8 | 1 | 4 | 0 | 35 |
| 9 | 6 | 1 | 8 | 0 | 71 |
| 10 | 3 | 1 | 6 | 1 | 143 |

A parsing process in the foregoing Table 2 is described: First, the first parameter 3.14 includes an integer part 3 and a fractional part 0.14, and the fractional part 0.14 includes a first digit 1 and a second digit 4 from a lowest digit to a highest digit. At an initial stage of a loop, fractionDigits₀ corresponds to the first digit 1, fractionDigits₁ corresponds to the second digit 4, and each carry value carry and mantissa fractionRaw are initialized to 0.

A first loop update process is entered, that is, f =1. First, calculation of 2×4+n is performed on the second digit 4. The carry value is 0, the fractionDigits₁ is updated to 8, 8<10, the carry value remains 0, calculation of 2×1+n is performed on the second digit 1, and the carry value is 0, so fractionDigits₀ is updated to 2, 2<10, the carry value is 0, and the mantissa is 0 (an initialized mantissa)×2+0, that is, the mantissa is 0.

A second loop update process is entered, that is, f=2. In the first loop update process, the first digit is updated to 2, and the second digit is updated to 8. First, calculation of 2×8+n is performed on the second digit 8. The carry value is 0, an obtained result is 16, 16>10, fractionDigits1 is updated to 6, the carry value is updated to 1, calculation of 2×2+n is performed on the second digit 1, and the carry value is 1, so the fractionDigits₀ is updated to 5, 5<10, the carry value is 0, and the mantissa is 0 (a mantissa obtained through the first loop update)×2+0, that is, the mantissa is 0.

A third loop update process is entered, that is, f=3. In the second loop update process, the first digit is updated to 5, and the second digit is updated to 6. First, calculation of 2×6+n is performed on the second digit 6. The carry value is 0, an obtained result is 12, 12>10, fractionDigits₁ is updated to 2, the carry value is updated to 1, calculation of 2×5+n is performed on the second digit 5, the carry value is 1, and an obtained result is 11, 11>10, so the fractionDigits₀ is updated to 1, the carry value is 1, and the mantissa is 0 (a mantissa obtained through the second loop update)×2+1 (an updated carry value), that is, the mantissa is 1.

A fourth loop update process is entered, that is, f=4. In the third loop update process, the first digit is updated to 1, and the second digit is updated to 2. First, calculation of 2×2+n is performed on the second digit 2. The carry value is 0, an obtained result is 4, 4<10, fractionDigits₁ is updated to 4, the carry value is updated to 0, calculation of 2×1+n is performed on the second digit 1, and the carry value is 0, an obtained result is 2, 2<10. Therefore, fractionDigits₀ is updated to 2, a carry value is 0, and a mantissa is 1 (a mantissa obtained through the second loop update)×2+0, that is, the mantissa is 2.

For a subsequent loop process, refer to the foregoing loop process. Details are not described herein again.

Operation 412: Determine a mantissa determined in an F^{th} loop as an integer representation of the fractional part.

For example, it is defined that f=f+1 when f is less than F, and operation 412 is started to be performed again. The mantissa determined in the F^{th} loop is determined as the integer representation of the fractional part when f is equal to F. In some embodiments, the mantissa determined in the F^{th} loop is converted into a binary representation corresponding to the number of fractional digits, and the fractional part in the first parameter is represented in the number of digits of the integer representation in a binary form.

Taking the first parameter 3.14 and the number of fractional digits F=10 as an example, a parsing process of integer representation of the fractional part of the first parameter 3.14 is shown in Table 2.

It may be learned from Table 2 that the integer representation of the fractional part of the first parameter 3.14 is 143.

Operation 414: Obtain an integer representation of the first parameter according to a sum of a product of the integer part and 2 to the power F and the integer representation of the fractional part. F represents a number of fractional digits.

In some embodiments, the sum of the product of the integer part and 2 to the power F and the integer representation of the fractional part is determined as the integer representation of the first parameter when the first parameter is a positive number. Alternatively, a negative number of the sum of the product of the integer part and 2 to the power F and the integer representation of the fractional part is determined as the integer representation of the first parameter when the first parameter is a negative number.

For example, the integer representation of the integer part may be represented as mantissa·2^{F}. The integer representation of the first parameter may be represented as raw=mantissa·2^{F}+fractionRaw when the first parameter is a positive number. The integer representation of the first parameter may be represented as raw=−(mantissa·2^{F}+fractionRaw) when the first parameter is a negative number.

Taking the first parameter 3.14 and the number of fractional digits F=10 as an example, the integer representation of the first parameter of the first parameter may be represented as raw=3·2¹⁰+143=3215.

Operation 416: Determine a constant generic corresponding to the at least one parameter according to the integer representation corresponding to the at least one parameter, where the constant generic corresponding to the parameter is configured for representing a product of the integer representation corresponding to the parameter and 2 to a power of −F, and F represents a number of fractional digits.

Take an example in which a first parameter is multiplied by a second parameter for description. For example, an integer representation of the first parameter is represented as I, a number of fractional digits is F2, an integer representation of the second parameter is represented as J, a number of fractional digits is F3, and a number of fractional digits of calculation result data is F1.

A constant generic corresponding to the first parameter is fixed (F2, I)=I·2^{-F}, and a constant generic corresponding to the second parameter is fixed (F3,J)=J·2^{-F}. Calculation result data is k·2^{-F1}=I·J·2^{-F2-F3}.

Operation 418: Perform calculation according to the constant generic corresponding to the at least one parameter to obtain calculation result data.

In some embodiments, when a sum of the number of fractional digits corresponding to the at least one parameter is greater than the number of fractional digits of the calculation result data, the integer representation corresponding to the at least one parameter is converted into a signed integer representation corresponding to the at least one parameter. A number of digits of the signed integer representation is twice a number of digits of the integer representation. The number of digits of the integer representation is a number of digits of a generated integer representation of first parameter. Calculation is performed according to the signed integer representation corresponding to the at least one parameter to obtain first calculation data. A difference between the sum of the number of fractional digits corresponding to the at least one parameter and the number of fractional digits corresponding to the calculation result data is calculated to obtain an offset value R. A sum of the first calculation data and 2 to the power of R−1 is calculated to obtain second calculation data. The second calculation data is right-shifted by R digits to obtain the calculation result data.

For example, when a sum F2+F3 of the numbers of the fractional digits respectively corresponding to the first parameter and the second parameter is greater than the number of fractional digits F1 of the calculation result data, the integer representations respectively corresponding to the first parameter and the second parameter are converted into signed integer representations respectively corresponding to the first parameter and the second parameter, and the number of digits of the signed integer representations is twice the number of digits of the integer representation. For example, if the integer representation of the first parameter is 32 bits, the integer representation of the first parameter is converted into a 64-bit signed integer representation. A difference between the sum of the numbers of fractional digits respectively corresponding to the first parameter and the second parameter and the number of fractional digits corresponding to the calculation result data is calculated to obtain an offset value R=F1−F2−F3. A sum of the first calculation data and 2 to the power of R−1 is calculated to obtain second calculation data. The second calculation data is right-shifted by R digits to obtain the calculation result data.

In some embodiments, for low rounding requirements, or to pursue higher performance, the foregoing operation of rounding an offset may not be performed.

For implementation of half-value rounding up of addition, subtraction, and division, the foregoing method is used if a shift direction of the integer part in a calculation process is right shift.

In some embodiments, calculation is performed according to a constant generic corresponding to the at least one parameter to obtain the calculation result data when a sum of the number of fractional digits corresponding to the at least one parameter is less than or equal to the number of fractional digits of the calculation result data.

Operation 420: Control, according to the calculation result data when the calculation result data is movement-related data, the virtual object to move; or control, according to the calculation result data when the calculation result data is interaction-related data, the virtual object to interact with another virtual object.

For example, if the calculation result data is related to movement, and the virtual object is controlled, according to the calculation result data, to move. The virtual object may be a virtual character controlled by a user, or may be a virtual object displayed on a user interface. This is not limited in this application.

For example, if the calculation result data is related to interaction, the virtual object is controlled, according to the calculation result data, to interact with another virtual object. The virtual object may be a virtual character controlled by a user, or may be a virtual object displayed on a user interface. This is not limited in this application. The another virtual object may be a virtual character controlled by a user, or may be a virtual object displayed on a user interface. For example, interaction between virtual characters, for example, interaction between a virtual character and a virtual object. For example, a virtual character attacks another virtual character. For another example, a virtual character collects a virtual object.

The foregoing operations 402 to 420 are all performed by a client that controls the virtual object. For example, a game battle has two virtual objects D1 and D2, where the virtual object D1 is controlled by a client 1, and the virtual object D2 is controlled by a client 2. If the virtual object D1 and the virtual object D2 interact with each other, the client 1 and the client 2 independently perform the foregoing operations 402 to 420 to obtain calculation result data, and control the virtual object D1 and the virtual object D2 according to the calculation result data, so as to control the virtual objects, and render a state of the game battle in real time in the clients. By the software implementation method for converting a parameter represented by a fraction into an integer representation according to the embodiments of this application, a client constructs an integer representation of a parameter by the foregoing method without relying on a compiler or hardware, so that uncertainty of the parameter represented by the fraction caused by inherent defects of the compiler or the hardware can be avoided, and certainty of integer representations of parameters obtained by different clients is ensured, thereby ensuring certainty of the calculation result data. That is, calculation result data obtained by various clients is the same. Therefore, the various clients can independently simulate physical interaction generated by controlling the virtual objects, without worrying about inconsistency of the calculation result data obtained by the various clients. Therefore, control of the various clients on the virtual objects can be maintained consistent. A server does not need to perform calculation on a parameter for controlling the virtual object when control of the various clients on the virtual objects can be maintained consistent, thereby further releasing computing power of the server, and reducing a quantity of parameters that need to be transmitted through a network.

In the technical solution provided in the embodiments of this application, a fractional part and an integer part of a parameter are respectively parsed to obtain an integer representation corresponding to the parameter, thereby ensuring certainty of the integer representation of the parameter. In a process of calculating the at least one parameter, calculation is performed by using a signed integer representation to avoid the problem of integer overflow or precision loss due to a limitation of a represented digit range. A virtual object is controlled by a lock-step synchronization method, and various clients may independently simulate physical interaction generated by controlling the virtual object to generate a consistent result, thereby releasing computing power of the server, and reducing traffic transmitted by the network.

According to the method provided in this embodiment, a mantissa in a current loop is determined based on a mantissa obtained through a previous loop iterative update and a carry value obtained in the current loop, and a final mantissa corresponding to a number of fractional digits is determined as an integer representation of a fraction based on a loop process, thereby improving efficiency of determining the integer representation.

According to the method provided in this embodiment, the first parameter is traversed from a highest digit of the first parameter, and is traversed to a position of a decimal point to obtain an integer part of the first parameter, thereby improving efficiency of obtaining the integer part.

According to the method provided in this embodiment, in a process of extracting the integer part of the first parameter, a first variable is set, and an operation is performed based on the first variable and a digit obtained by traversing to obtain the integer part of the first parameter until traversing to the position where the decimal point is located, thereby improving efficiency of obtaining the integer part.

According to the method provided in this embodiment, when a fractional part following the position of the decimal point is extracted, an array is created, digits following the decimal point are traversed, and elements in the array are updated, so that the fractional part on which integer conversion can be performed following the decimal point is determined, thereby improving efficiency of extracting the fractional part.

According to the method provided in this embodiment, when an integer representation of the first parameter is determined, and adaptive processing is performed on each of the integer part and the fractional part, where the integer part is multiplied by 2 to the power of F, a processing result of the integer representation of the fractional part and a processing result of the integer part are added to obtain the integer representation of the first parameter, and the integer part is distinguished from the fractional part, thereby improving integer conversion efficiency of the first parameter.

According to the method provided in this embodiment, a calculation mode of the integer representation is adjusted and adapted for the positive and negative cases of the first parameter, thereby increasing a processing capability of performing integer representation conversion on the first parameter.

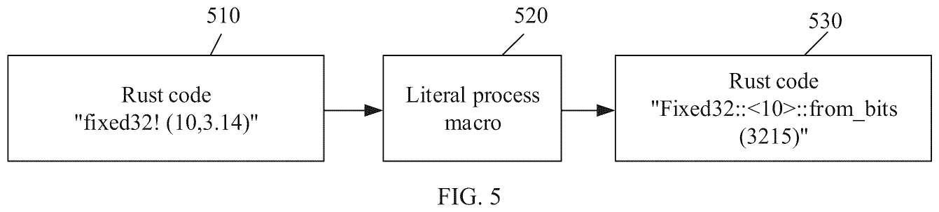

In some embodiments, the foregoing software implementation method may be implemented by using Rust code. As shown in FIG. 5, a user needs to invoke a process macro fixed32! when constructing a required fixed-point number literal, and a number of fractional digits “10” and literal content “3.14” are input as a parameter 510.

In a process of compiling the Rust code 530, between operations of lexical analysis and grammatical analysis, a literal process macro 520 uses an algorithm of parsing a character string to construct a fixed-point number, and finally, a final binary representation (an unsigned integer “3215” in the figure) is obtained. Fixed32::from_bits is implemented as a constant function in Rust. Therefore, the fixed-point number literal constructed in this mode may continue to participate in calculation of another constant in a compiling period.

The code for implementing the foregoing software implementation method is not limited in this application, and may alternatively be other code different from the Rust code.

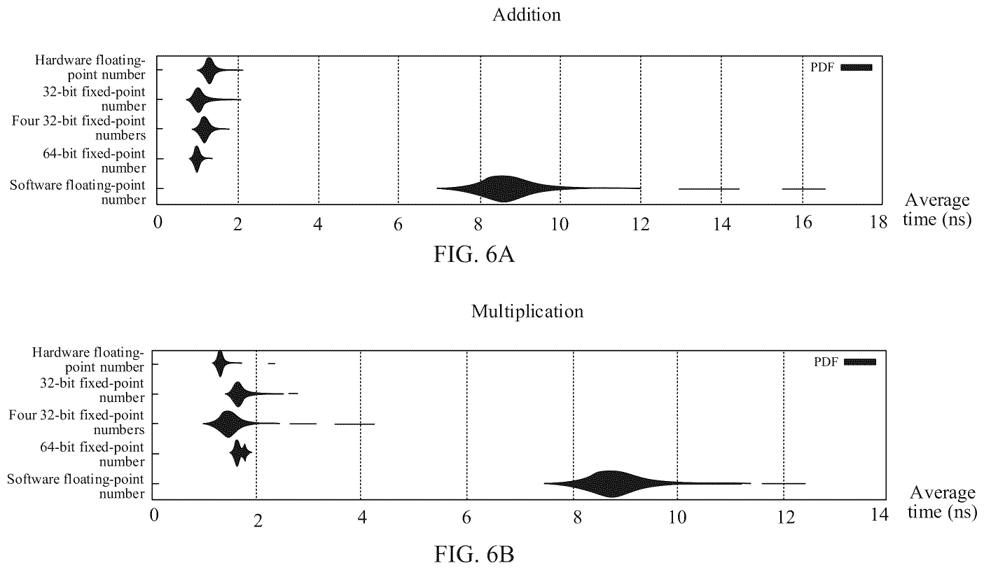

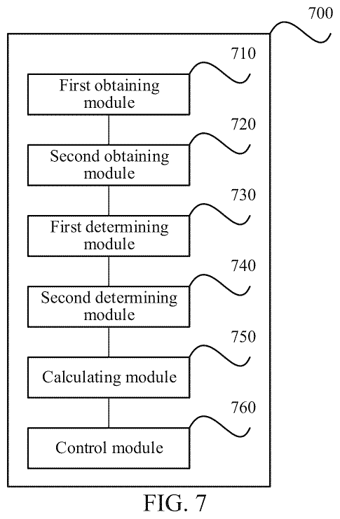

Please refer to FIGS. 6A and 6B, experimental comparison is performed for the technical solution provided in the embodiments of this application.

through the technical solution provided in the embodiments of this application, a user can directly construct the fixed-point number literal by using a floating-point number without introducing runtime overhead.

Four arithmetic machine instruction code implemented by the constant generic only includes one integer four-arithmetic operation and one shift operation. Considering a half-value rounding-up rule, one more integer addition is added, which can optimize single instruction multiple data (SIMD) while maintaining certainty. By directly specifying a result of the number of fractional digits, additional overhead and precision loss caused by conversion of the number of fractional digits of different fixed-point numbers in conventional implementation are avoided.

In FIG. 6A, addition performance of a hardware floating-point number, a 32-bit fixed-point number, four 32-bit fixed-point numbers accelerated by using an SIMD instruction, a 64-bit fixed-point number, and a software floating-point number is compared from top to bottom. In a FIG. 6B, multiplication performance of a hardware floating-point number, a 32-bit fixed-point number, four 32-bit fixed-point numbers accelerated by using a SIMD instruction, a 64-bit fixed-point number, and a software floating-point number is compared from top to bottom. It can be found that the performance of the 32-bit fixed-point number in addition and multiplication is equivalent to that of the hardware floating-point number, and the 32-bit fixed-point number can achieve up to 4× acceleration by using the SIMD instruction under a condition of ensuring certainty.

The following are apparatus embodiments of this application, which may be configured to perform the method embodiments of this application. For details not disclosed in the apparatus embodiments of this application, refer to the method embodiments of this application.

Please refer to FIG. 7, which is a block diagram of an apparatus for controlling a virtual object according to an embodiment of this application. The apparatus has functions for implementing the foregoing method for controlling a virtual object. The functions may be implemented by hardware, or may alternatively be implemented by hardware executing corresponding software. The apparatus 700 may include: a first obtaining module 710, a second obtaining module 720, a first determining module 730, a second determining module 740, and a control module 760.

The first obtaining module 710 is configured to obtain at least one parameter configured for controlling a virtual object;

The second obtaining module 720 is configured to: obtain, for a first parameter represented by a fraction in the at least one parameter, an integer part and a fractional part of the first parameter.

The first determining module 730 is configured to determine an integer representation of the fractional part according to a preset number of fractional digits. The number of fractional digits is configured for representing a number of digits of the fractional part when the integer representation of the first parameter is generated.

The second determining module 740 is configured to determine an integer representation of the first parameter according to the integer representation of the fractional part and the integer part.

The control module 760 is configured to control the virtual object according to the integer representation corresponding to the at least one parameter.

In some embodiments, the first determining module 730 is further configured to: perform update digit by digit in an f^{th} loop update in order from a lowest digit to a highest digit of the fractional part to obtain a carry value in an f^{th} loop, where f is a positive integer with an initial value of 1; determine an f^{th} mantissa according to the carry value in the f^{th} loop, where the f^{th} mantissa is a value determined based on the carry value and a preset algorithm; and define f=f+1 when f is less than F, and perform update digit by digit again in the order from the lowest digit to the highest digit of the fractional part to obtain the carry value in the f^{th} loop, where F represents a number of fractional digits; or determine, when f is equal to than F, the mantissa determined in the F^{th} loop as the integer representation of the fractional part.

In some embodiments, the first determining module 730 is further configured to: initialize a first carry value to 0; obtain an n^{th} digit in the fractional part in the order from the lowest digit to the highest digit of the fractional part in the f^{th} loop update, where an initial value of n represents the lowest digit of the fractional part; calculate a product of the n^{th} digit and 2, and add the first carry value to obtain a processed n^{th} digit; assign a difference between the processed n^{th} digit and 10 to the n^{th} digit when the processed n^{th} digit is greater than or equal to 10, where the first carry value is assigned to 1; assign the processed n^{th} digit to the n^{th} digit when the processed n^{th} digit is less than 10, where the first carry value is assigned to 0; define n=n−1 when n is greater than 1, and obtain the n^{th} digit in the fractional part in the order from the lowest digit to the highest digit of the fractional part again; or determine, when n is equal to 1, the first carry value obtained by processing the first digit as the carry value in the f^{th} loop.

In some embodiments, the first determining module 730 is further configured to calculate a product of an (f−1)^{th} mantissa and 2, and add the carry value in the f^{th} loop to obtain the f^{th} mantissa, where when f=1, a 0th mantissa is 0.

In some embodiments, the second obtaining module 720 is further configured to traverse the first parameter digit by digit from the highest digit of the first parameter until traversing to a decimal point of the first parameter to obtain the integer part of the first parameter.

In some embodiments, the second obtaining module 720 is further configured to: initialize a value of a first variable to 0; obtain an i^{th} digit in the first parameter in order from the highest digit to a lowest digit of the first parameter, where an initial value of i corresponds to the highest digit of the first parameter; calculate a product of the first variable and 10, add the i^{th} digit, and assign an obtained result to the first variable; define i=i+1 when the i^{th} digit is not followed by the decimal point, and start to perform the operation of obtaining an i^{th} digit in the first parameter again; and determine a value of the first variable as the integer part of the first parameter when the i^{th} digit is followed by the decimal point.

In some embodiments, the second obtaining module 720 is further configured to traverse digits following the decimal point of the first parameter one by one from the highest digit, and obtaining 1 digits to obtain the fractional part of the first parameter, where 1 is a positive integer and 1 is less than or equal to a maximum threshold.

In some embodiments, the second obtaining module 720 is further configured to: create an array; obtain a j^{th} digit for the digits following the decimal point of the first parameter, where an initial value of j corresponding to the highest digit following the decimal point of the first parameter; add the j^{th} digit to the array in order from the highest digit to a lowest digit of the first parameter; define j=j+1 when the j^{th} digit is followed by another digit and j is less than the maximum threshold, and start to perform the operation of obtaining a j^{th} digit again; and obtain, according to the 1 digits recorded in the array, the fractional part of the first parameter when the j^{th} digit is not followed by another digit; or obtain, according to the 1 digits recorded in the array, the fractional part of the first parameter when the j^{th} digit is followed by another digit and j is equal to the maximum threshold.

In some embodiments, the second determining module 740 is further configured to obtain the integer representation of the first parameter according to a sum of a product of the integer part and 2 to the power F and the integer representation of the fractional part, where F represents a number of fractional digits.

In some embodiments, the second determining module 740 is further configured to: determine the sum of the product of the integer part and 2 to the power F and the integer representation of the fractional part as the integer representation of the first parameter when the first parameter is a positive number; or determine a negative number of the sum of the product of the integer part and 2 to the power F and the integer representation of the fractional part as the integer representation of the first parameter when the first parameter is a negative number.

In some embodiments, the apparatus further includes a calculating module 750, configured to perform calculation on the integer representation corresponding to the at least one parameter to obtain calculation result data; and
a control module 760, configured to control the virtual object according to the calculation result data.

In some embodiments, the calculating module 750 is further configured to: determine, according to the integer representation corresponding to the at least one parameter, a constant generic corresponding to the at least one parameter, where the constant generic corresponding to the parameter is configured for representing a product of the integer representation corresponding to the parameter and 2 to the power of −F, and F represents a number of fractional digits; and perform calculation according to the constant generic corresponding to the at least one parameter to obtain the calculation result data.

In some embodiments, the calculating module 750 is further configured to: convert, when a sum of the number of fractional digits corresponding to the at least one parameter is greater than the number of fractional digits of the calculation result data, the integer representation corresponding to the at least one parameter into a signed integer representation corresponding to the at least one parameter, where a number of digits of the signed integer representation being twice a number of digits of the integer representation, and the number of digits of the integer representation is a number of digits of a generated integer representation of first parameter; perform calculation according to the signed integer representation corresponding to the at least one parameter to obtain first calculation data; calculate a difference between the sum of the number of fractional digits corresponding to the at least one parameter and the number of fractional digits corresponding to the calculation result data to obtain an offset value R; calculate a sum of the first calculation data and 2 to the power of R−1 to obtain second calculation data; and right-shift the second calculation data by R digits to obtain the calculation result data.

In some embodiments, the control module 760 is further configured to control, according to the calculation result data when the calculation result data is movement-related data, the virtual object to move; or control, according to the calculation result data when the calculation result data is interaction-related data, the virtual object to interact with another virtual object.

In some embodiments, at least one parameter includes parameters respectively provided by at least two clients, and the at least two clients respectively control the virtual object in a lock-step synchronization mode.

According to the technical solutions provided in the embodiments of this application, at least one parameter configured for controlling a virtual object is converted into an integer representation corresponding to the at least one parameter, calculation is performed according to the integer representation corresponding to the at least one parameter to obtain calculation result data, and the virtual object is controlled according to the calculation result data. This application provides a software implementation method for converting a parameter represented by a fraction into an integer representation. A client constructs an integer representation of a parameter by using the same method described above, without relying on a compiler or hardware, so that uncertainty of the parameter represented by the fraction caused by inherent defects of the compiler or the hardware can be avoided, and certainty of integer representations of parameters obtained by different clients is ensured, thereby ensuring certainty of calculation result data, and maintaining control consistency of a virtual object by various clients.

When functions of the apparatus provided by the foregoing embodiment are realized, only the division of various foregoing functional modules is exemplified. In actual applications, the foregoing functions can be assigned to different functional modules to complete according to actual needs, that is, the content structure of the device is divided into different functional modules to complete all or part of the functions described above.

With regard to the apparatus in the above-mentioned embodiments, specific modes of performing operations by each module are described in detail in the embodiments related to the method, which is not described in detail herein.

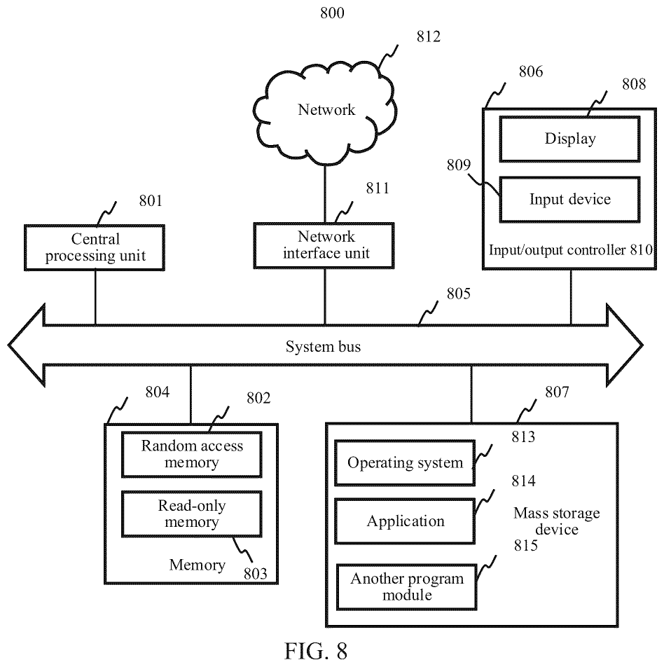

Please refer to FIG. 8, which is a schematic structural diagram of a computer device according to an embodiment of this application. The computer device may be any electronic device having data calculating, processing, and storage capabilities. The computer device may be configured to implement the method for controlling a virtual object according to the foregoing embodiments. Specifically:
the computer device 800 includes a central processing unit (CPU), a graphics processing unit (GPU), or a field programmable gate array (FPGA)) 801, a system memory 804 including a random-access memory (RAM) 802 and a read-only memory (ROM) 803, and a system bus 805 connecting the system memory 804 and the CPU 801. The computer device 800 further includes a basic input output (I/O) system 806 assisting in transmitting information between components in a server, and a mass storage device 807 configured to store an operating system 813, an application 814, and another program module 815.

In some embodiments, the basic I/O system 806 includes a display 808 configured to display information and an input device 809 such as a mouse or a keyboard that is configured for a user to input information. The display 808 and the input device 809 are both connected to the CPU 801 by using an input/output controller 810 connected to the system bus 805. The basic I/O system 806 may further include the input and output controller 810 configured to receive and process input from a plurality of other devices such as a keyboard, a mouse, and an electronic stylus. Similarly, the input/output controller 810 further provides an output to a display screen, a printer, or another type of output device.

The mass storage device 807 is connected to the CPU 801 through a mass storage controller (not shown) connected to the system bus 805. The mass storage device 807 and a computer-readable medium associated with the large-capacity storage device provide non-volatile storage for the computer device 800. That is, the mass storage device 807 may include a computer-readable medium (not shown) such as a hard disc or a compact disc read-only memory (CD-ROM).

Generally, the computer-readable medium may include a computer storage medium and a communication medium. The computer storage medium includes volatile and non-volatile media, and removable and non-removable media implemented by any method or technology configured for storing information such as computer-readable instructions, data structures, program modules, or other data. The computer storage medium includes a random access memory (RAM), a read-only memory (ROM), an erasable programmable read-only memory (EPROM), an electrically erasable programmable read-only memory (EEPROM), a flash memory or another solid-state storage technology, a CD-ROM, a digital video disc (DVD) or another optical storage, a cassette, a magnetic tape, a disc storage or another magnetic storage device. Certainly, a person skilled in art can learn that the computer storage medium is not limited to the foregoing several types. The system memory 804 and the mass storage device 807 may be collectively referred to as a memory.

According to the embodiments of this application, the computer device 800 may further be connected, through a network such as the Internet, to a remote computer on the network for running. That is, the computer device 800 may be connected to a network 812 through a network interface unit 811 connected to the system bus 805, or may be connected to another type of network or a remote computer system (not shown) by using a network interface unit 811.

The memory further includes a computer program. The computer program is stored in the memory and configured to be executed by one or more processors to implement the foregoing method for controlling a virtual object.

In an exemplary embodiment of this embodiment, a non-transitory computer-readable storage medium is further provided. The non-transitory computer-readable storage medium has a computer program stored thereon. The computer program implements, when executed by a processor, the foregoing method for controlling a virtual object.

In some embodiments, the computer-readable medium may include: a read-only memory (ROM), a random access memory (RAM), a solid state drive (SSD), an optical disc, or the like. The RAM may include a resistance random access memory (ReRAM) and a dynamic random access memory (DRAM).

In an exemplary embodiment, a computer program product is further provided. The computer program product includes a computer program, and the computer program is stored in a non-transitory computer-readable storage medium. A processor of a computer device reads computer instructions from the non-transitory computer-readable storage medium, and the processor executes the computer program, so that the computer device performs the foregoing method for controlling a virtual object.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. User data and signals involved in this application are all authorized by a user or are fully authorized by all parties, and collection, use, and processing of related data need to comply with related laws and regulations and standards of related countries and regions. For example, operations of a user on a virtual object involved in this application are all obtained with sufficient authorization.

What is claimed is:

1. A method for controlling a virtual object performed by a computer device, comprising:
obtaining a first parameter configured for controlling a virtual object;
determining an integer part and a fractional part of the first parameter;
determining an integer representation of the fractional part according to a preset number of fractional digits;
determining an integer representation of the first parameter according to the integer representation of the fractional part and the integer part; and
controlling the virtual object according to the integer representation corresponding to the first parameter.

2. The method according to claim 1, wherein the determining the integer representation of the fractional part according to a preset number of fractional digits comprises:
performing update digit by digit in an f^{th} loop update in order from a lowest digit to a highest digit of the fractional part to obtain a carry value in an f^{th} loop, f being a positive integer with an initial value of 1; and
determining an f^{th} mantissa according to the carry value in the f^{th} loop, the f^{th} mantissa being a value determined based on the carry value and a preset algorithm;
defining f=f+1 when f is less than F, and performing update digit by digit again in the order from the lowest digit to the highest digit of the fractional part to obtain the carry value in the f^{th} loop, wherein F represents a number of fractional digits; or
determining, when f is equal to than F, the mantissa determined in the F^{th} loop as the integer representation of the fractional part.

3. The method according to claim 1, wherein the determining the integer part of the first parameter comprises:
traversing the first parameter digit by digit from the highest digit of the first parameter until traversing to a decimal point of the first parameter to obtain the integer part of the first parameter.

4. The method according to claim 1, wherein the determining the fractional part of the first parameter comprises:
traversing digits following the decimal point of the first parameter one by one from the highest digit, and obtaining 1 digits to obtain the fractional part of the first parameter, wherein 1 is a positive integer and 1 is less than or equal to a maximum threshold.

5. The method according to claim 1, wherein the determining the integer representation of the first parameter according to the integer representation of the fractional part and the integer part comprises:
obtaining the integer representation of the first parameter according to a sum of a product of the integer part and 2 to the power F and the integer representation of the fractional part, wherein F represents a number of fractional digits.

6. The method according to claim 1, wherein the controlling the virtual object according to the integer representation corresponding to the first parameter comprises:
performing calculation on the integer representation corresponding to the first parameter to obtain calculation result data; and
controlling the virtual object according to the calculation result data.

7. The method according to claim 6, wherein the controlling the virtual object according to the calculation result data comprises:
when the calculation result data is movement-related data, controlling the virtual object to move according to the movement-related data; and
when the calculation result data is interaction-related data, controlling the virtual object to interact with another virtual object according to the calculation result data.

8. The method according to claim 1, wherein the first parameter comprises parameters respectively provided by at least two clients, and the at least two clients respectively control the virtual object in a lock-step synchronization mode.

9. The method according to claim 1, wherein the number of fractional digits is configured for representing a number of digits of the fractional part when the integer representation of the first parameter is generated.

10. A computer device, comprising a processor and a memory, the memory storing a computer program, and the processor being configured to execute the computer program to implement a method for controlling a virtual object including:
obtaining a first parameter configured for controlling a virtual object;
determining an integer part and a fractional part of the first parameter;
determining an integer representation of the fractional part according to a preset number of fractional digits;
determining an integer representation of the first parameter according to the integer representation of the fractional part and the integer part; and
controlling the virtual object according to the integer representation corresponding to the first parameter.

11. The computer device according to claim 10, wherein the determining the integer representation of the fractional part according to a preset number of fractional digits comprises:
performing update digit by digit in an f^{th} loop update in order from a lowest digit to a highest digit of the fractional part to obtain a carry value in an f^{th} loop, f being a positive integer with an initial value of 1; and
determining an f^{th} mantissa according to the carry value in the f^{th} loop, the f^{th} mantissa being a value determined based on the carry value and a preset algorithm;
defining f=f+1 when f is less than F, and performing update digit by digit again in the order from the lowest digit to the highest digit of the fractional part to obtain the carry value in the f^{th} loop, wherein F represents a number of fractional digits; or
determining, when f is equal to than F, the mantissa determined in the F^{th} loop as the integer representation of the fractional part.

12. The computer device according to claim 10, wherein the determining the integer part of the first parameter comprises:
traversing the first parameter digit by digit from the highest digit of the first parameter until traversing to a decimal point of the first parameter to obtain the integer part of the first parameter.

13. The computer device according to claim 10, wherein the determining the fractional part of the first parameter comprises:
traversing digits following the decimal point of the first parameter one by one from the highest digit, and obtaining 1 digits to obtain the fractional part of the first parameter, wherein 1 is a positive integer and 1 is less than or equal to a maximum threshold.

14. The computer device according to claim 10, wherein the determining the integer representation of the first parameter according to the integer representation of the fractional part and the integer part comprises:
obtaining the integer representation of the first parameter according to a sum of a product of the integer part and 2 to the power F and the integer representation of the fractional part, wherein F represents a number of fractional digits.

15. The computer device according to claim 10, wherein the controlling the virtual object according to the integer representation corresponding to the first parameter comprises:
performing calculation on the integer representation corresponding to the first parameter to obtain calculation result data; and
controlling the virtual object according to the calculation result data.

16. The computer device according to claim 15, wherein the controlling the virtual object according to the calculation result data comprises:
when the calculation result data is movement-related data, controlling the virtual object to move according to the movement-related data; and
when the calculation result data is interaction-related data, controlling the virtual object to interact with another virtual object according to the calculation result data.

17. The computer device according to claim 10, wherein the first parameter comprises parameters respectively provided by at least two clients, and the at least two clients respectively control the virtual object in a lock-step synchronization mode.

18. The computer device according to claim 10, wherein the number of fractional digits is configured for representing a number of digits of the fractional part when the integer representation of the first parameter is generated.

19. A non-transitory computer-readable storage medium, storing a computer program, the computer program being loaded and executed by a processor of a computer device to implement a method for controlling a virtual object including:
obtaining a first parameter configured for controlling a virtual object;
determining an integer part and a fractional part of the first parameter;
determining an integer representation of the fractional part according to a preset number of fractional digits;
determining an integer representation of the first parameter according to the integer representation of the fractional part and the integer part; and
controlling the virtual object according to the integer representation corresponding to the first parameter.

20. The non-transitory computer-readable storage medium according to claim 19, wherein the determining the integer part of the first parameter comprises:
traversing the first parameter digit by digit from the highest digit of the first parameter until traversing to a decimal point of the first parameter to obtain the integer part of the first parameter.
